(19) United States
(12) Patent Application Publication
(10) Pub. No.: US 2012/0223611 A1
(43) Pub. Date: Sep. 6, 2012

(54) STATOR AND METHOD FOR MANUFACTURING STATOR

(75) Inventors: Atsushi Watanabe, Toyota-shi (JP); Masayoshi Haga, Nagoya-shi (JP)

(73) Assignee: TOYOTA JIDOSHA KABUSHIKI KAISHA, Toyota-shi Aichi-ken (JP)

(21) Appl. No.: 13/508,379

(22) PCT Filed: Nov. 5, 2009
(86) PCT No.: PCT/JP2009/068891

§ 371 Date: May 7, 2012

(51) Int. Cl. H02K 1/16; G11B 5/127

(52) U.S. Cl. 310/254.1; 29/603.01; 29/729

(57) ABSTRACT

Disclosed is a stator which can be made compact and can produce high output, and also disclosed is a method for manufacturing the stator. A stator comprises a split stator core provided with teeth portions and slots, and a double coil formed of a flat type conductor, wherein the split stator core has a first block of six slots of U, V and W phases and a second adjoining block, the flat type conductor in the first slot of U phase forms a first loop coil together with the flat type conductor in the second slot of U phase, the flat type conductor in the second slot of U phase forms a second loop coil together with the flat type conductor in the first slot of U phase, and the second loop coil is arranged on the inner circumference of the first loop coil.

### TECHNICAL FIELD

The present invention relates to a technique of improving the space factor of a stator in order to achieve a compact and high-power motor.

### BACKGROUND ART

In recent years, the needs for hybrid electric vehicles, electric vehicles, and others have been increased. Accordingly, motors have been studied to be used for the driving power of vehicles. However, such motors to be mounted in the vehicles are demanded for development of high power and downsizing. Particularly, hybrid electric vehicles are strictly demanded for size reduction in view of the placement of a motor in an engine room.

Therefore, various studies have been made to achieve downsizing and high power of motors.

Patent Document 1 discloses a technique related to a conductor part for stator frame in a multi-phase power generator.

A stator core includes outer slots. A flat rectangular conductor provides a plane of an in-slot conductor portion to be inserted in each slot. The flat rectangular conductor is shaped into an almost U-like form when seen in plan view perpendicularly to the plane and a sinuous form when seen in front view along the plane. Such flat rectangular conductor is set in the stator core. Accordingly, a coil end of the stator can be shortened, thereby improving the space factor.

Patent Document 2 discloses a technique related to a crank-shaped consecutively wound coil, a distributed winding stator, and a method of forming them.

After a flat rectangular conductor is wound in hexagon shape, a crank-shaped portion serving as a coil end is formed by a die. Such flat rectangular conductor is placed in a stator core to eliminate interference between coils in the coil end, thus contributing to an increase in the space factor of the stator and a reduction in size.

Patent Document 3 discloses a technique related to a rotary electric machine and a manufacturing method thereof.

When a coil assembly wound from an inner circumferential side to an outer circumferential side is to be placed in slots of a stator core, the coil assembly is inserted from the coil outer circumferential side into an outer layer side of one slot and from the coil inner circumferential side into an inner layer side of the other slot. Accordingly, the rotary electric machine including distributed winding coils can be manufactured in a simplified work and also can have an improved space factor of the slots.

Patent Document 4 discloses a technique related to a stator of a rotary electric machine, and the rotary electric machine.

A flat rectangular conductor is wound in wave form to form a wound coil having a plurality of phases. Split teeth are inserted from outside and fixed in grooves in an outer annular portion of a stator core. Thus, the stator core can be manufactured with high precision.

### RELATED ART DOCUMENTS

### Patent Documents

Patent Document 1: JP 3756516 B2

Patent Document 2: JP 4234749 B2

Patent Document 3: JP 2008-125212 A

Patent Document 4: JP 2009-131093 A

### DISCLOSURE OF THE INVENTION

### Problems to be Solved by the Invention

However, Patent Documents 1 to 4 may cause the following problems.

In general, a stator using a distributed winding coil can be more developed for high power as compared with a stator using a concentrated winding coil and hence can more easily solve the problem with cogging torque. However, if the depth of slots in the stator cores are made larger and the number of turns of a coil is increased to develop high power of the stator using the distributed coil as shown in Patent Documents 1 and 2, a problem with interference between coils occurs.

In the techniques disclosed in Patent Documents 1 and 2, there is little clearance between adjacent coils. It therefore seems difficult to increase the number of turns of each coil any more. In shaping a flat rectangular conductor, the bending radius of the flat rectangular conductor is restricted. Thus, it also seems hard to increase a cross-sectional area of the flat rectangular conductor any more.

Consequently, the methods in Patent Documents 1 and 2 are considered unsuitable for further development of high power.

Patent Document 3 shows only a concrete method of shaping a coil by winding a circular wire from inner to outer circumference into a flat shape to form a coil, clamping a portion of the coil to be inserted in a slot, then twisting that portion. This method seems unsuitable for a flat rectangular conductor.

Because of the use of a manner of winding the flat rectangular conductor by stacking or overlapping the conductor on the outer circumference, a coil end tends to become large. This seems inadequate for downsizing of a stator.

Patent Document 4 uses a wave winding coil in distributed winding. The wave winding coil needs weaving of a flat rectangular conductor. This requires a complicated forming work and also a large-sized assembling machine to stack all the flat rectangular conductors in a planar manner and then wind the stacked flat rectangular conductors into an annular ring shape. Accordingly, there occur problems that assembling is difficult and cost reduction is hard to achieve.

Consequently, in view of the techniques shown in Patent Documents 1 to 4, additional devices or ideas are necessary to more reduce the size and develop the high power of a stator.

The present invention has been made to solve the above problems and has a purpose to provide a stator and a stator manufacturing method, whereby enabling downsizing and development of high power.

### Means of Solving the Problems

To achieve the above purpose, one aspect of the invention provides a stator configured as below.

(1) In a stator comprising: a stator core including teeth portions and slots formed between the teeth portions; and coils each being made of a flat rectangular conductor and placed in the slots, the slots include three-phase slot blocks including a first group consisting of a U-phase first slot, a U-phase second slot, a V-phase first slot, a V-phase second slot, a W-phase first slot, and a W-phase second slot, which are arranged in sequence, and a second group of the three-phase slot blocks being arranged adjacent to the first group, the conductor placed in a U-phase first slot of the first group and the conductor placed in a U-phase second slot of the second group forms a first loop, the conductor placed in a U-phase second slot of the first group and the conductor placed in a U-phase first slot of the second group forms a second loop, and the second loop is placed on an inner circumference of the first loop.

(2) In the stator described in (1), the conductor extending out of the U-phase first slot is deformed for lane change in a range corresponding to two slots.

(3) In the stator described in (1) or (2), a coil end portion of the first loop is formed with a first protrusion, and a coil end portion of the second loop is formed with a second protrusion placed on an inner circumference of the first protrusion.

(4) In one of the stators described in (1) to (3), one end of the first loop is connected to one end of the second loop.

To achieve the above purpose, further, a stator manufacturing method of another aspect of the invention is configured as below.

(5) In a method of manufacturing a stator comprising: a stator core including teeth portions and slots formed between the teeth portions; and coils each being made of a flat rectangular conductor and placed in the slots, the method including: a first step of winding the conductor in a plurality of turns in an overlapping relation to form an octagonal coil; a second step of forming a pair of protrusions in coil end portions of the octagonal coil; a third step of forming the coil formed with the protrusions into a circular arc shape; and a fourth step of forming lane-change portions in the pair of protrusions.

(6) In the stator manufacturing method described in (5), the second step includes pressing an outer surface of the octagonal coil by a press mechanism from surrounding four directions of the fixed octagonal coil to form the pair of protrusions.

(7) In the stator manufacturing method described in (5) or (6), the third step includes fixing the coil formed with the protrusions and then pressing a die having a curved surface against the coil formed with the protrusions in an axial direction to form the coil including the protrusions into the circular arc shape.

(8) In one of the stator manufacturing methods described in (5) to (7), the fourth step includes holding the pair of protrusions of the coil formed in the circular arc shape by a right holding die and a left holding die and then displacing the left holding die with respect to the right holding die to form the lane-change portion in the pair of protrusions.

Furthermore, to achieve the above purpose, a stator manufacturing apparatus of another aspect of the invention is configured as below.

(9) In a stator manufacturing apparatus for manufacturing a stator comprising: a stator core including teeth portions and slots formed between the teeth portions; and coils each being made of a flat rectangular conductor and placed in the slots, a coil fixing part for fixing an octagonal coil formed of the conductor wound in a plurality of turns in an overlapping relation; and a press mechanism for pressing an outer surface of the octagonal coil from surrounding four directions of the fixed octagonal coil, a pair of protrusions is formed in the octagonal coil.

(10) The stator manufacturing apparatus described in (9), further includes: a fixing mechanism for fixing both ends of the coil formed with the protrusions; and a die having a curved surface which is pressed against the coil formed with the protrusions in an axial direction of the coil, the apparatus being configured to form the coil formed with the protrusions into a circular arc shape.

(11) The stator manufacturing apparatus described in (10), further includes: a right holding die and a left holding die for holding the pair of protrusions formed in the circular arc shape, and a drive mechanism for displacing the left holding die with respect to the right holding die, the lane-change portion is formed in each of the pair of protrusions of the coil formed into the circular arc shape.

### Effects of the Invention

A stator of one aspect of the invention configured as above can provide the following operations and effects.

The above configuration (1) provides the stator comprising: a stator core including teeth portions and slots formed between the teeth portions; and coils each being made of a flat rectangular conductor and placed in the slots, wherein the slots include three-phase slot blocks including a first group consisting of a U-phase first slot, a U-phase second slot, a V-phase first slot, a V-phase second slot, a W-phase first slot, and a W-phase second slot, which are arranged in sequence, and a second group of the three-phase slot blocks being arranged adjacent to the first group, the conductor placed in a U-phase first slot of the first group and the conductor placed in a U-phase second slot of the second group forms a first loop, the conductor placed in a U-phase second slot of the first group and the conductor placed in a U-phase first slot of the second group forms a second loop, and the second loop is placed on an inner circumference of the first loop.

Since the flat rectangular conductor is formed into double coils each having the first loop and the second loop, more allowance for the lane-change portions can be sufficiently provided.

When a coil formed of a conductor in a loop shape is to be inserted in a stator core, the conductor has to be arranged in planar pattern on an end face of the stator core, as disclosed in Patent Documents 1 and 2. In this case, the end face of the stator core has a limited area and thus the number of conductor portions to increase the number of turns of each coil could not be easily increased. When a coil is designed as a distributed winding, concentrically winding coils will interfere with each other and therefore each coil end portion needs a space for a lane-change portion. Due to this lane-change portion, the width of the coil likely becomes problematic.

To avoid the above disadvantages, the present invention provides the double coil structure in which the second loop is formed on the inner circumference side of the first loop, so that the end face of the stator core can be utilized in three dimensions. As a result, the number of turns of each coil can be increased. Even when the number of turns is increased, the lane-change portions can prevent interference of adjacent coils.

Since the first loop and the second loop are assembled in an overlapping relation to form a double coil, a stator core with deep slots can be adopted without much increasing the thickness of the coil end. Consequently, the space factor of the stator and the demand for downsizing can be satisfied.

The aforementioned configuration of the invention described in (2) provides that, in the stator described in (1), the conductor extending out of the U-phase first slot is deformed for lane change in a range corresponding to two slots.

The lane change is necessary as long as a concentrically winding coil is adopted for a distributed winding stator. When the concentrically winding coil is inserted by skipping a plurality of slots as mentioned above, interference is caused between the adjacent coils. The above configuration is adopted to avoid such interference.

To be concrete, assuming that a flat rectangular conductor to be inserted in slots is referred to as an in-slot conductor portion, a first loop of the U-phase coil of which one in-slot conductor portion is inserted in the U-phase first slot of the first group, while the other in-slot conductor portion is inserted in the U-phase second slot of the second group. The first loop of the V-phase coil is placed adjacent thereto, in which one in-slot conductor portion is inserted in the V-phase first slot of the first group and the other in-slot conductor portion is inserted in a V-phase second slot of the second group.

The first loop of the V-phase coil described above has to be arranged so that a portion to be inserted in the U-phase first slot of the first group is placed under the first loop of the U-phase coil while a portion to be inserted in the U-phase second slot of the second group is placed above the first loop of the U-phase coil. More specifically, the first loop and the second loop provide a double structure. One includes, sequentially from above, a U-phase first loop, a U-phase second loop, a V-phase first loop, and a V-phase second loop, while the other includes, sequentially from above, a V-phase first loop, a V-phase second loop, a U-phase first loop, and a U-phase second loop.

The lane-change portion needed as above could use only one slot region if the flat rectangular conductor is placed in planar pattern on the end face of the stator core. In the double coil provided in the present invention, however, the lane-change portion can use a double region corresponding to two slots. Accordingly, it is preferable to prepare as wide a width as possible in view of the bending radius.

In this description, a “region corresponding to two slots” represents the width corresponding to two slots and two teeth portions assuming that one set of a slot and a tooth is considered as one slot region.

This is because it is effective to increase the cross sectional area of the rectangular conductor in order to increase the space factor. As larger the cross sectional area, the bending radius also becomes relatively larger. Thus, the present invention can provide a stator with a high space factor.

The aforementioned configuration of the invention described in (3) provides that, in the stator described in (1) or (2), a coil end portion of the first loop is formed with a first protrusion, and a coil end portion of the second loop is formed with a second protrusion placed on an inner circumference of the first protrusion.

Since the above first protrusion and the second protrusion are provided in the coil, design flexibility can be enhanced. Accordingly, the rectangular conductor with higher flatness is more effectively used for a coil.

With the first protrusion and the second protrusion, firstly, the adjacent coils can be easily deformed for lane change.

In the case where a coil is wound into a hexagonal shape, its two sides protrude like an isosceles triangle on a coil end. In this case, if the coils are arranged so that their isosceles triangle portions pass each other, the coils have to be spaced from each other in view of the thickness of the conductor, needing enough width for the lane changes. In contrast, the coils each including the first protrusion and the second protrusion can easily avoid the interference with the adjacent coils.

For forming the first loop or the second loop, because of the stator structure, it is further necessary to perform edgewise bending of the conductor. However, for providing the first protrusion and the second protrusion, the conductor is bent in a direction along a side of thinner thickness, not in the edgewise bending direction. The conductor can therefore be bent relatively easily with a small bending radius.

As a result, the design flexibility of the stator can be enhanced. This can contribute to ensure easy connection with the bus bars; for example, the terminal portions of the coil are extended outward to pass under the first loop and the second loop without much extending the coil end.

Enhanced design flexibility can help to simplify the process of manufacturing the stator. This stator can provide more advantages.

The above configuration of the invention described in (4) provides that, in one of the stators described in (1) to (3), one end of the first loop is connected to one end of the second loop.

Since the first loops and the second loops of the coils are connected, connection of the bus bars is not necessary after the coils are placed in the stator core. That is, the first loop and the second loop, which are separate, can be connected with each other in advance. This makes it possible to reduce the number of bus bars and enhance a work space for bus bar connection.

Bas bar connection at the coil end is necessary for electrical connection of coils. However, if the coils are close to each other, a connecting work may become troublesome. It is also conceivable to need connection with the bus bars by avoiding the terminal of one of the coils in some cases. This is not desirable.

However, since the coils with the first loops and the second loops connected in advance are placed in the stator core, connecting portions with the bus bars at the coil end can be reduced, which leads to improvement of working efficiency.

Furthermore, the stator manufacturing method of another aspect of the invention having the above features can provide the following operations and effects.

The aforementioned configuration of the invention described in (5) provides a method of manufacturing a stator comprising: a stator core including teeth portions and slots formed between the teeth portions; and coils each being made of a flat rectangular conductor and placed in the slots, the method including: a first step of winding the conductor in a plurality of turns in an overlapping relation to form an octagonal coil; a second step of forming a pair of protrusions in coil end portions of the octagonal coil; a third step of forming the coil formed with the protrusions into a circular arc shape; and a fourth step of forming lane-change portions in the pair of protrusions.

With the above configuration, it is possible to form the double coil including the protrusions. Since the double coils are set in the stator core, the stator with a high space factor and with a short coil end can be formed.

That is, this configuration can contribute to development of high power and size reduction of the stator.

The aforementioned configuration of the invention described in (6) provides that, in the stator manufacturing method described in (5), the second step includes pressing an outer surface of the octagonal coil by a press mechanism from surrounding four directions of the fixed octagonal coil to form the pair of protrusions.

In many cases, the octagonal coil is made of high thermal conductive metal such as copper and aluminium which are easy to process. Accordingly, after the octagonal coil is formed, the coil is fixed to a base and then both sides of a portion which will become a protrusion are pressed by the pressing mechanism, thereby forming the pair of protrusions.

The aforementioned configuration of the invention described in (7) provides that, in the stator manufacturing method described in (5) or (6), the third step includes fixing the coil formed with the protrusions and then pressing a die having a curved surface against the coil formed with the protrusions in an axial direction to form the coil including the protrusions into the circular arc shape.

When the die having the curved surface is pressed against the coil formed with the protrusions, thereby deforming the coil, the coil can be shaped into the uniform circular arc form. Because the coils having the same shape are assembled together in overlapping relation to form a cage-shaped coil, the overlapping portions are desired to be accurately uniform in shape. With the use of the die, such coils can be realized.

The aforementioned configuration of the invention described in (8) provides that, in one of the stator manufacturing methods described in (5) to (7), the fourth step includes holding the pair of protrusions of the coil formed in the circular arc shape by a right holding die and a left holding die and then displacing the left holding die with respect to the right holding die to form the lane-change portion in the pair of protrusions.

For forming the lane-change portion, a force is applied to displace the left holding die with respect to the right holding die, thereby forming the lane-change portion in the pair of protrusions. The coils are assembled in overlapping relation to form the cage-shaped coil, so that higher accuracy of the overlapping portions than accuracy of the lane-change portion is more advantageous. Since the right and left holding dies hold the coil, the portions that will be overlapped in forming the cage coil can provide more accuracy.

A stator manufacturing apparatus in another aspect of the invention can provide the following operations and effects.

The configuration of the invention described in (9) provides a stator manufacturing apparatus for manufacturing a stator comprising: a stator core including teeth portions and slots formed between the teeth portions; and coils each being made of a flat rectangular conductor and placed in the slots, wherein a coil fixing part for fixing an octagonal coil formed of the conductor wound in a plurality of turns in an overlapping relation; and a press mechanism for pressing an outer surface of the octagonal coil from surrounding four directions of the fixed octagonal coil, a pair of protrusions is formed in the octagonal coil.

Since the apparatus includes the coil fixing part and the pressing mechanism for pressing outer surfaces of the octagonal coil, the second step of the stator manufacturing method described (5) and (6) can be realized, thus deforming the outer shape of the octagonal coil.

To form the stator described in (3), the first protrusion has to be formed in the coil end portion the first loop and the second protrusion has to be formed in the coil end portion the second loop. With the above configuration, the first protrusion or the second protrusion can be easily formed.

The aforementioned configuration of the invention described in (10) provides that the stator manufacturing apparatus described in (9) further includes: a fixing mechanism for fixing both ends of the coil formed with the protrusions; and a die having a curved surface which is pressed against the coil formed with the protrusions in an axial direction of the coil, the apparatus being configured to form the coil formed with the protrusions into a circular arc shape.

With the use of the die having the curved surface, the coil formed with the protrusions can be shaped into a circular arc form. Thus, the third step described in (7) can be realized.

The aforementioned configuration of the invention described in (11) provides that, the stator manufacturing apparatus described in (10) further includes: a right holding die and a left holding die for holding the pair of protrusions formed in the circular arc shape, and a drive mechanism for displacing the left holding die with respect to the right holding die, the lane-change portion is formed in each of the pair of protrusions of the coil formed into the circular arc shape.

For assembling the coils each formed in the circular-arc shape in an overlapping relation, it is necessary to avoid interference between adjacent coils. Therefore, the lane-change portions are formed in each coil, so that the stator with short coil ends can be formed as with the invention described in (5). Further, a force is applied with use of the drive mechanism and the right and left holding dies, so that the lane-change portions can be formed one each at the corresponding positions of the upper and lower coil end portions of the circular-arc coil. With this configuration, the fourth step described in (8) can be realized.

### BRIEF DESCRIPTION OF THE DRAWINGS

FIG. 1 is a perspective view of a stator in a first embodiment;

FIG. 2 is a perspective view of a double coil in the first embodiment;

FIG. 3 is a top view of the double coil in the first embodiment;

FIG. 4 is a top view of a jig for forming a coil protrusion in the first embodiment;

FIG. 5 is a top view showing a forming state using the coil protrusion forming jig in the first embodiment;

FIG. 6 is a side view of a curve deforming jig in the first embodiment;

FIG. 7 is a side view showing a coil forming state using the curve deforming jig in the first embodiment;

FIG. 8 is a side view of a lane-change portion forming jig in the first embodiment;

FIG. 9 is in a side view showing a state where a lane-change portion is formed in a coil by use of the lane-change forming jig in the first embodiment;

FIG. 10 is a schematic perspective view of double coils assembled in overlapping relation in the first embodiment;

FIG. 11 is a perspective view showing a state where a piece is to be inserted in a cage-shaped coil in the first embodiment;

FIG. 12 is a schematic view showing the cage-shaped coil in which the piece is inserted in the first embodiment;

FIG. 13 is a plan view showing a first loop of a U-phase coil formed in a stator core in the first embodiment;

FIG. 14 is a plan view showing a second loop of the U-phase coil formed in the stator core in the first embodiment;

FIG. 15 is a partial perspective view of a coil end portion of a double coil in a second embodiment;

FIG. 16 is a partial perspective view of a stator in the second embodiment;

FIG. 17 is a partial perspective view of a coil end portion of a double coil in a third embodiment, seen from an inner periphery side; and

FIG. 18 is a partial perspective view of the coil end portion of the double coil in the third embodiment, seen from an outer periphery side.

### MODE FOR CARRYING OUT THE INVENTION

A detailed description of a first preferred embodiment of embodying the present invention will now be given referring to the accompanying drawings.

### First Embodiment

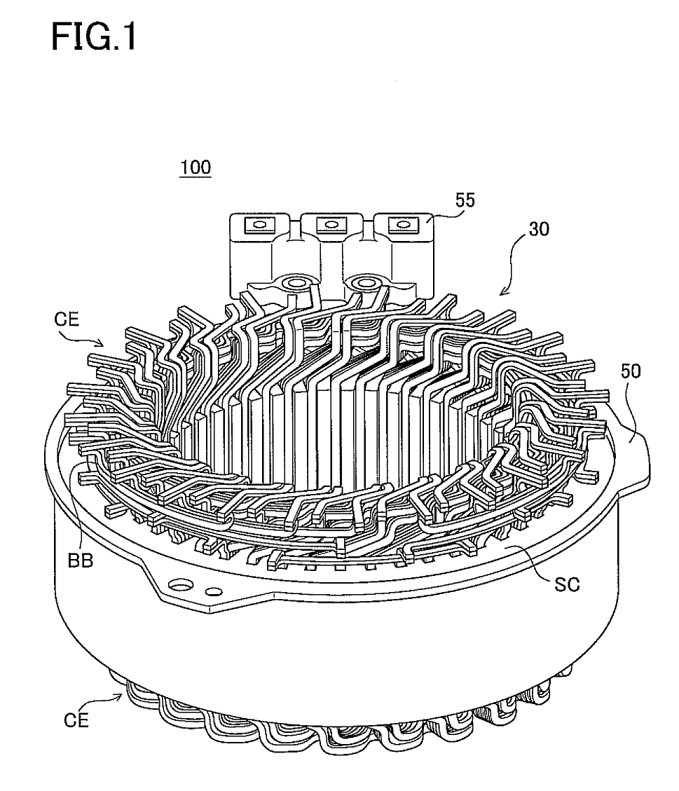

FIG. 1 is a perspective view of a stator in the first embodiment.

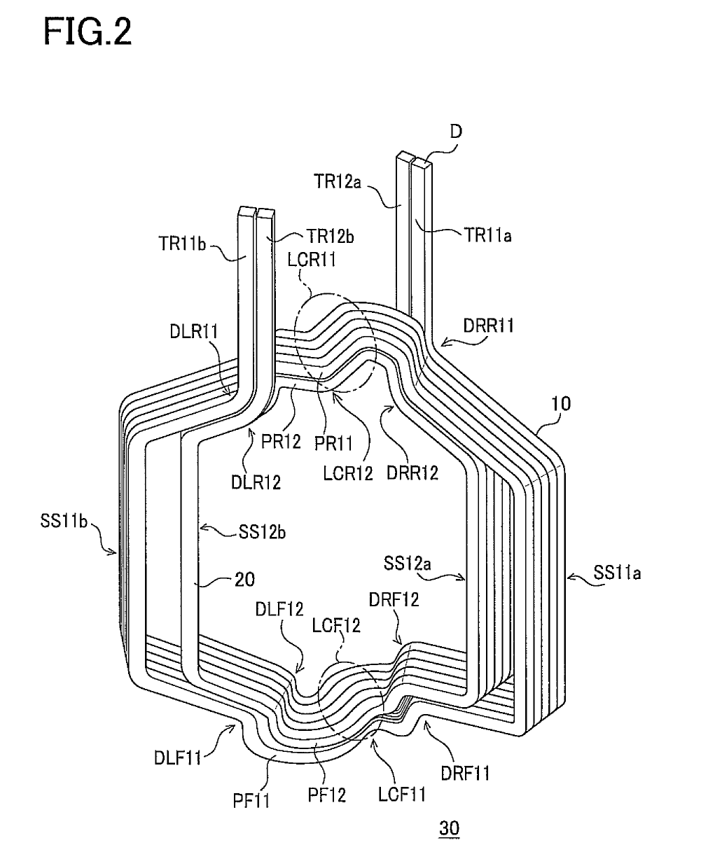

FIG. 2 is a perspective view of a double coil.

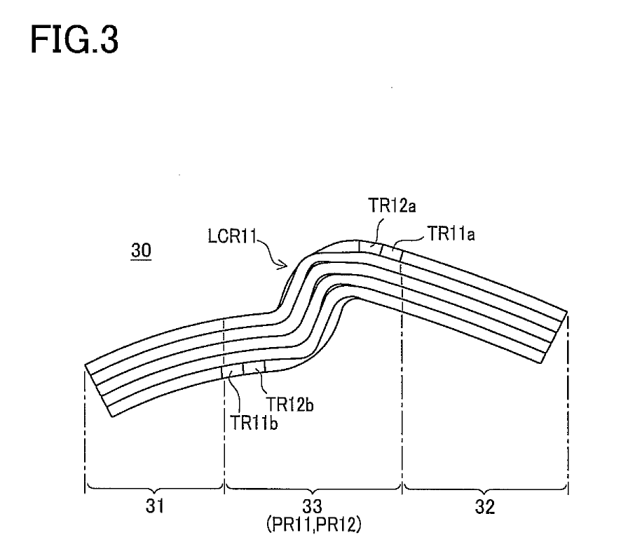

FIG. 3 is a top view of the double coil, seen from above in FIG. 2.

A stator 100 includes double coils 30, a split stator core SC, an outer ring 50, and a terminal stand 55. The double coils 30 in FIG. 1 are connected with bus bars BB and coil end portions of the coils 30 are tilted.

Each double coil 30 includes a first loop coil 10 and a second loop coil 20 as shown in FIG. 2. Each of the first loop coil 10 and the second loop coil 20 is formed of a wound flat rectangular conductor (conductor wire) D.

This conductor D is made of a metal wire having a rectangular cross section and coated with insulating resin. The metal wire is made of high insulating metal and the insulating resin is high insulating resin such as enamel and PPS.

The first loop coil 10 includes a first terminal portion TR11a and a second terminal portion TR11b, and also a lead-side protrusion PR11 and a non-lead-side protrusion PF11. On both sides of the lead-side protrusion PR11, a lead-side right recess DRR11 and a lead-side left recess DLR11 are formed. On both sides of the non-lead-side protrusion PF11, a non-lead-side right recess DRF11 and a non-lead-side left recess DLF11 are formed. Further, the lead-side protrusion PR11 is formed with a lead-side lane-change portion LCR11 and the non-lead-side protrusion PF11 is formed with a non-lead-side lane-change portion LCF11.

The first loop coil 10 also includes a first in-slot conductor portion SS11a and a second in-slot conductor portion SS11b which are to be inserted in slots SCS of the stator core SC.

The second loop coil 20 includes, as with the first loop coil 10, a first terminal portion TR12a and a second terminal portion TR12b. Further, a lead-side protrusion PR12 and a non-lead-side protrusion PF12 are formed. On both sides of the lead-side protrusion PR12, a lead-side right recess DRR12 and a lead-side left recess DLR12 are formed. On both sides of the non-lead-side protrusion PF12, a non-lead-side right recess DRF12 and a non-lead-side left recess DLF12 are formed. The lead-side protrusion PR12 is formed with a lead-side lane-change portion LCR12 and the non-lead-side protrusion PF12 is formed with a non-lead-side lane-change portion LCF 12.

The second loop coil 20 also includes a first in-slot conductor portion SS12a and a second in-slot conductor portion SS12b.

The double coil 30 is formed by placing the second loop coil 20 on the inner circumferential side of the first loop coil 10 in overlapping relation.

The split stator core SC consists of twenty-four pieces 41 each of which is made of laminated electromagnetic steel plates and arranged in a cylindrical form, and the outer ring 50 is fit on the stator core SC to hold the double coils 30.

The stator core SC is provided, on its inner circumferential side, the slots SCS and the teeth portions 43 alternately arranged. Each piece 41 has a shape divided in the bottoms of the slots SCS to include two teeth portions 43.

The outer ring 50 is a cylindrical metal body formed with such a size that an inner periphery thereof conforms to an outer periphery of the stator core SC. The outer ring 50 is mounted around the stator core SC by shrink fitting. Accordingly, the inner periphery of the outer ring 50 is designed to be slightly smaller than the outer periphery of the stator core SC.

The terminal stand 55 is a connection port to be connected with an external connector not shown for the purpose of e.g. supplying electric power to the double coils 30 of the stator 100 after having been electrically connected, from a power source such as a secondary battery. In the first embodiment, the stator is configured for three phases and hence three connection ports are provided.

A method of forming the coil in the first embodiment will be explained below.

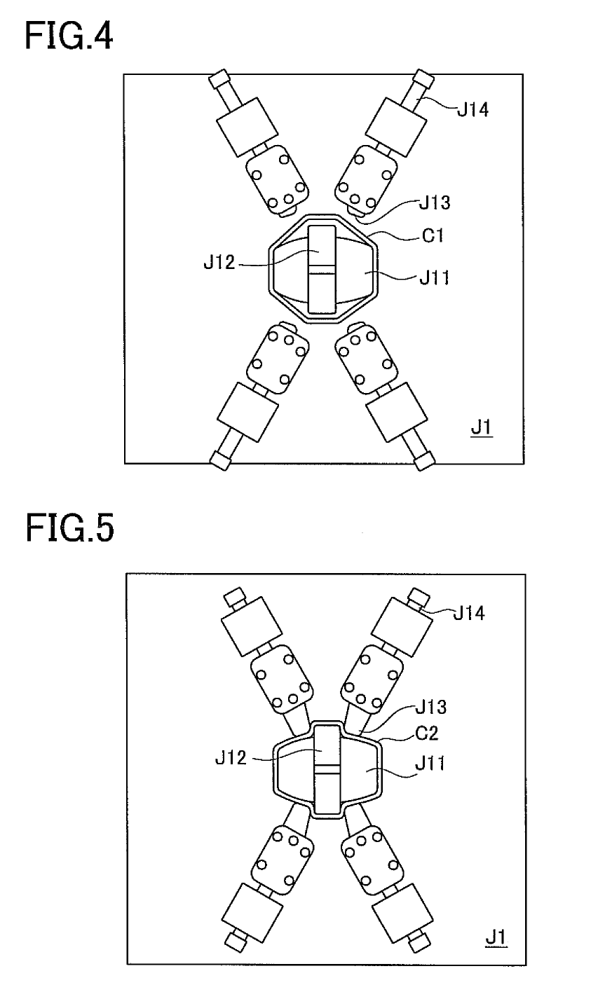

FIG. 4 is a top view of a coil protrusion forming jig. FIG. 5 is a top view showing a forming state using the coil protrusion forming jig.

Firstly, an octagonal initial coil C1 is formed by winding a flat rectangular conductor D by edge-wise bending. The initial coil C1 is set on a center holder J11 of the coil protrusion forming jig J1. The jig J1 corresponds to a coil fixing part. The center holder J11 and a protrusion guide J12 are placed in combination. As shown in FIG. 4, the initial coil C1 is put so as to surround the center holder J11 and the protrusion guide J12.

The coil protrusion forming jig J1 includes press jigs J13 corresponding to a press mechanism to shape the initial coil C1 to have the lead-side right recess DRR11 through the non-lead-side left recess DLF11 of the first loop coil 10 or the lead-side right recess DRR12 through the non-lead-side left recess DLF12 of the second loop coil 20.

While the initial coil C1 is set on the center holder J11 and the protrusion guide J12, a rod J14 of each press jig J13 is moved ahead, thereby forming recesses as shown in FIG. 5. As a result, the initial coil C1 is shaped into a protrusion-including coil C2 formed with the lead-side protrusion PR11 and the non-lead-side protrusion PF11 of the first loop coil 10 or the lead-side protrusion PR12 and the non-lead-side protrusion PF12 of the second loop coil 20.

It is to be noted that the initial coil C1 for the first loop coil 10 and the initial coil C1 for the second loop coil 20 are actually different in circumferential length but are described herein as being equal for convenience.

Actual shapes of the center holder J11 and the protrusion guide J12 of the protrusion forming jig J1 are different between the initial coil C1 for the first loop coil 10 and the initial coil C1 for the second loop coil 20. Accordingly, it is necessary to provide separate jigs respectively adapted to the different initial coils C1 or provide a variable guide mechanism.

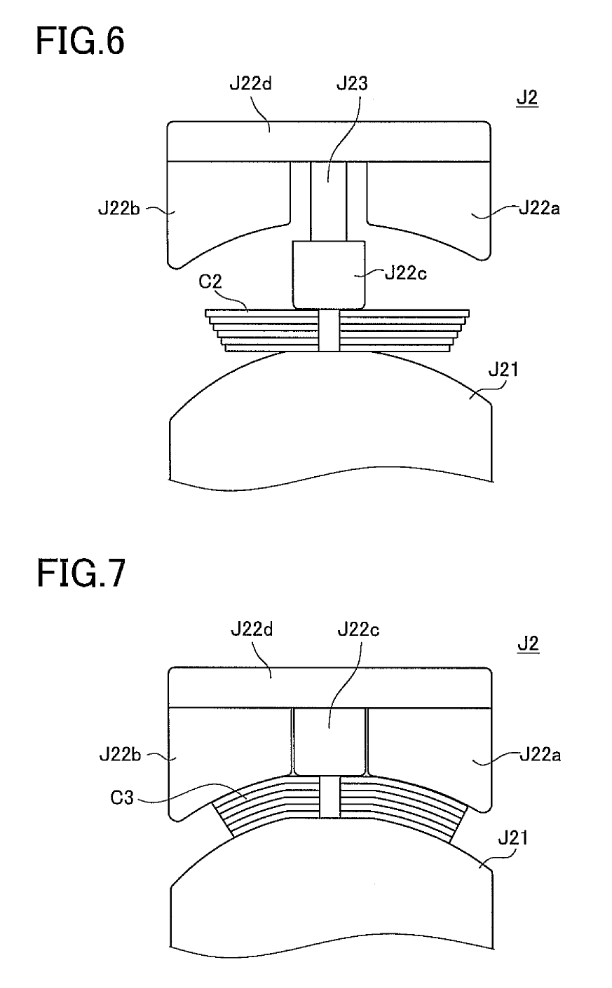

Successively, the protrusion including coil C2 shaped by forming the protrusions in the initial coil C1 has to be subjected to a step of deforming the coil C2 into a circular arc shape. FIG. 6 is a side view of a curve deforming jig. FIG. 7 shows a state where the coil is shaped by use of the curve deforming jig.

A curve deforming jig J2 includes a fixed die J21, a movable die J22, and a shaft J23.

The fixed die J21 has a curved surface necessary to deform the first loop coil 10 and the second loop coil 20 with a radius curvature required for placement thereof in the stator 100. The movable die J22 also has a similar curved surface and is arranged to be movable along the shaft J23 in a direction toward the fixed die J21.

The movable die J22 includes four components; a center holding member J22c corresponding to a fixing mechanism to press the protrusion including coil C2, a first curve forming die J22a and a second curve forming die J22b for deforming the protrusion including coil C2, and a die base J22d.

The first and second curve forming dies J22a and J22b are equal in radius curvature to the curved surface of the fixed die J21 (strictly speaking, the fixed die J21 and the thickness of a curve including coil C3 corresponds to the radius curvature of the second curve forming die J22b), enabling bending of the protrusion including coil C2.

While the coil C2 is set in the curve deforming jig J2, the coil C2 is held by the center holding member J22c, the first and second curve forming dies J22a and J22b fixed to the die base J22d are given thrust to move together with the die base J22d toward the fixed die J21, thereby deforming the coil C2. As a result, the coil C2 is deformed into a curve including coil C3 as shown in FIG. 7.

Further, an explanation is given to a step of forming, in the coil C3, a lead-side lane-change portion LCR11 and a non-lead-side lane-change portion LCF11 of the first loop coil 10 and a lead-side lane-change portion LCR12 and a non-lead-side lane-change portion LCF12 of the second loop coil 20.

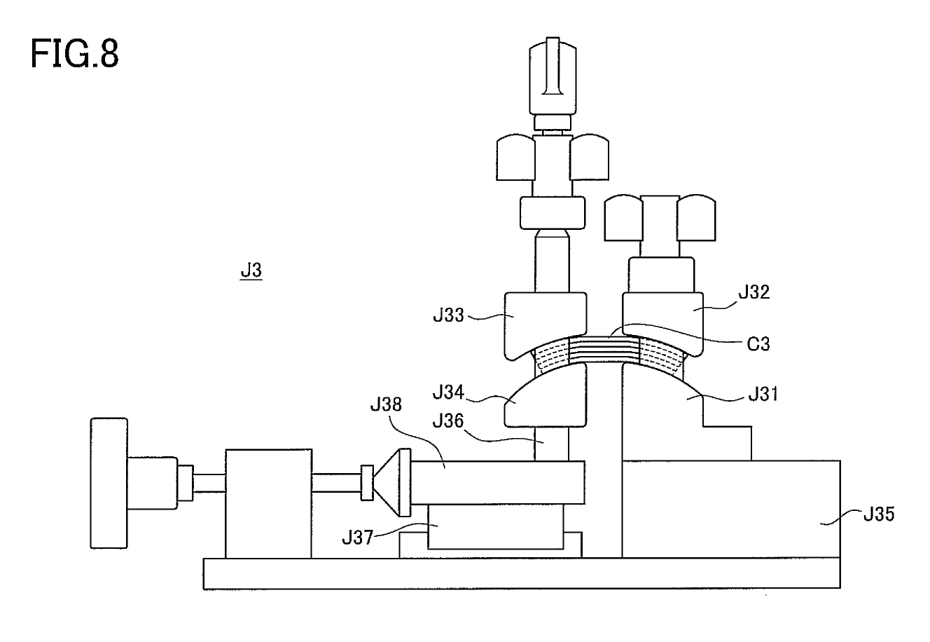

FIG. 8 is a side view related to a lane-change forming jig.

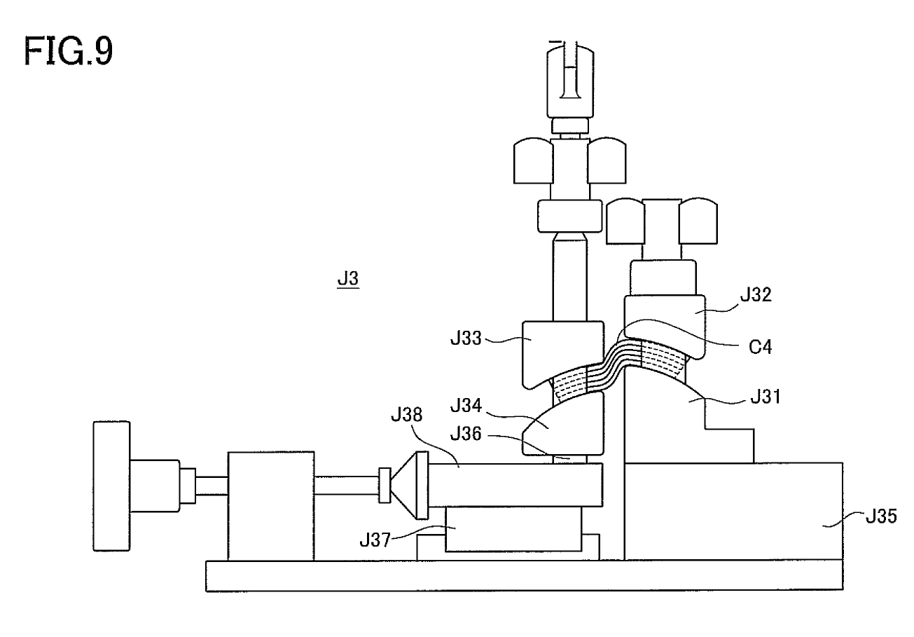

FIG. 9 is a side view showing a state where the lane-change portion is formed in the coil by the lane-change forming jig.

A lane-change forming jig J3 includes a fixing base J31, a fixing chuck J32, a movable chuck J33, and a movable base J34.

The fixing base J31 is placed on a base J35. The fixing base J31 and the fixing chuck J32 are movable in a direction that approaches the fixing base J31 to hold one end of the curve including coil C3.

The movable chuck J33 and the movable base J34 are held on a slide base J38 by a shaft 36 passing therethrough. The slide base J38 fixed to a slide guide J37 has a drive mechanism to be movable rightward and leftward in FIG. 8 relative to the fixing base J31. The movable chuck J33 and the movable base J34 have a drive mechanism to be movable upward and downward in FIG. 8 relative to the slide base J38. The movable chuck J33 and the movable base J34 are also arranged to hold the other end of the curve including coil C3.

The curve including coil C3 is held in such a state as shown in FIG. 8 by the lane-change forming jig J3. When the slide base J38 is moved ahead and simultaneously the movable chuck J33 and the movable base J34 clamping the other end of the coil C3 are moved down, a lane-change including coil C4 is formed as shown in FIG. 9.

This coil C4 is the first loop coil 10 or the second loop coil 20 shown in FIG. 2 and in a state where it can be installed in the split stator core SC.

The first loop coil 10 or the second loop coil 20 formed as above are stacked or assembled together to constitute the double coil 30.

The double coil 30 includes three zones as shown in FIG. 3, that is, an inner-circumferential zone 31, an outer-circumferential zone 32, and a protruding lane-change zone 33. The lane-change zone 33 is defined as a generic term of a range corresponding to the lead-side lane-change portion LCR11 of the lead-side protrusion PR11 or the non-lead-side lane-change portion LCF11 of the non-lead-side protrusion PF11 in the first loop coil 10 or the lead-side lane-change portion LCR12 of the lead-side protrusion PR12 or the non-lead-side lane-change portion LCF12 of the non-lead-side protrusion PF12 in the second loop coil 20.

After the those double coils 30 are stacked or assembled in overlapping relation in a cage form, forming a cage-shaped coil (cage coil) CB, the split stator core SC is inserted therein.

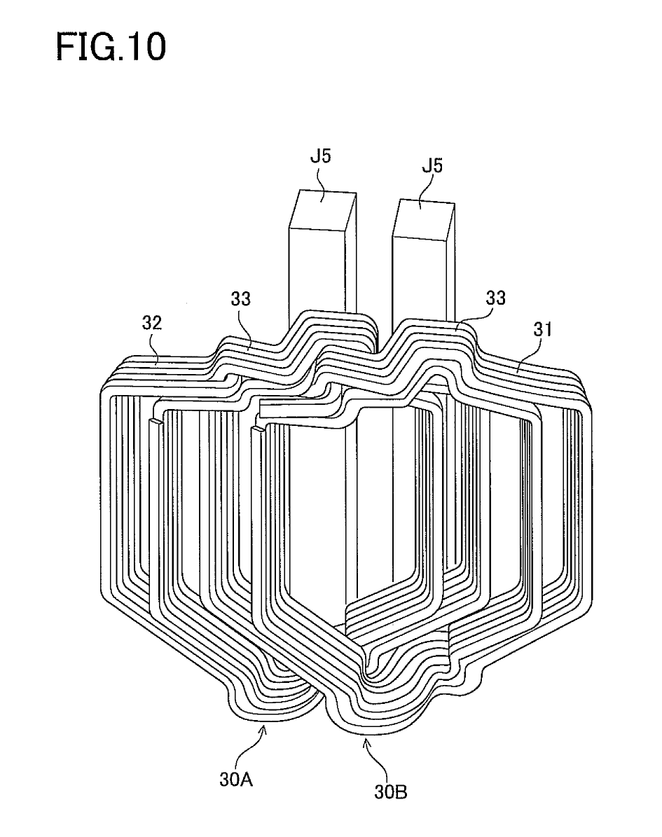

FIG. 10 is a schematic perspective view of the stacked double coils. It is to be noted that the first terminal portion TR11a, the second terminal portion TR11b, the first terminal portion TR12a, and the second terminal portion TR12b are omitted for convenience of explanation.

A double coil 30A and a double coil 30B are double coils 30 having the same shape and are arranged so that respective lane-change zones 33 are adjacent as shown in FIG. 10. Accordingly, the inner circumferential zone 31 of the double coil 30B is located under the lane-change zone 33 of the double coil 30A.

On the other hand, the inner circumferential zone 31 of the double coil 30A is located under the lane-change zone 33 of the double coil 30B.

It is to be noted that positioning jigs J5 are illustrated behind the double coils 30A and 30B. The positioning jigs J5 serve to position the double coils 30.

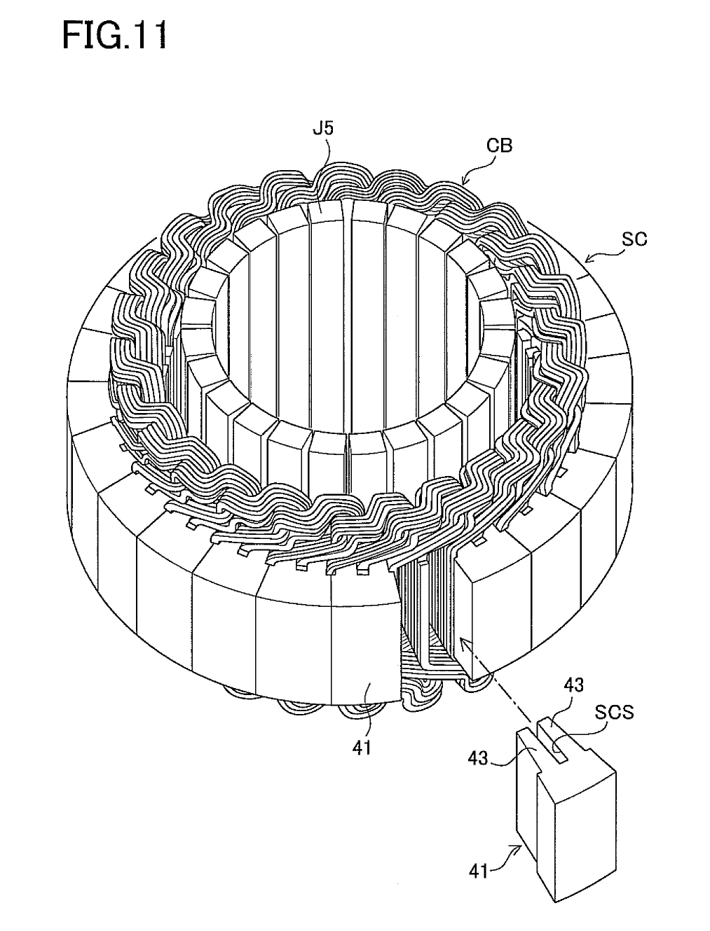

FIG. 11 is a perspective view showing a state where a piece is to be inserted in the cage coil. In this figure, as in FIG. 10, the first terminal portion TR11a, the second terminal portion TR11b, the first terminal portion TR12a, and the second terminal portion TR12b are omitted for convenience of explanation.

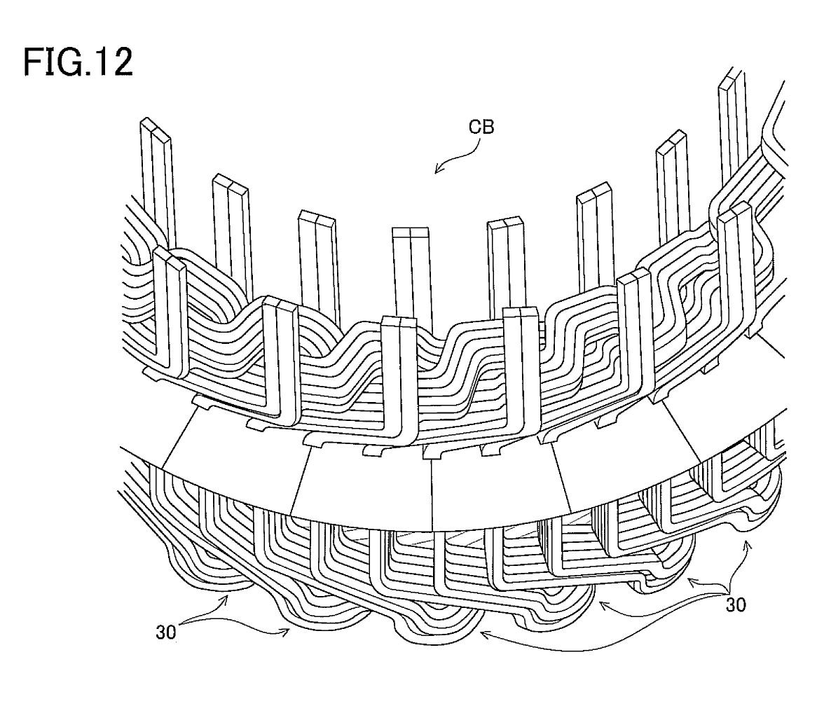

FIG. 12 is a schematic view showing the cage coil in which the piece is inserted. The pieces in FIG. 12 appear as only upper surfaces for explanation.

The cage coil CB is constituted of the double coils 30 sequentially stacked as shown in FIG. 10. This cage coil CB includes twenty-four sets of the double coils 30. The pieces 41 are inserted therein from outside, completing the cylindrical split stator core SC.

Finally, the outer ring 50 is shrink-fitted on the outer periphery of the stator core SC as shown in FIG. 1. The stator 100 is thus completed.

In the cage coil CB, as shown in FIG. 12, the first terminal portion TR11a, the second terminal portion TR11b, the first terminal portion TR12a, and the second terminal portion TR12b are formed to protrude. After shrink-fitting of the outer ring 50, those terminal portions TR11a, TR11b, TR12a, and TR12b are bent outward and connected with bus bars BB into a state shown in FIG. 1.

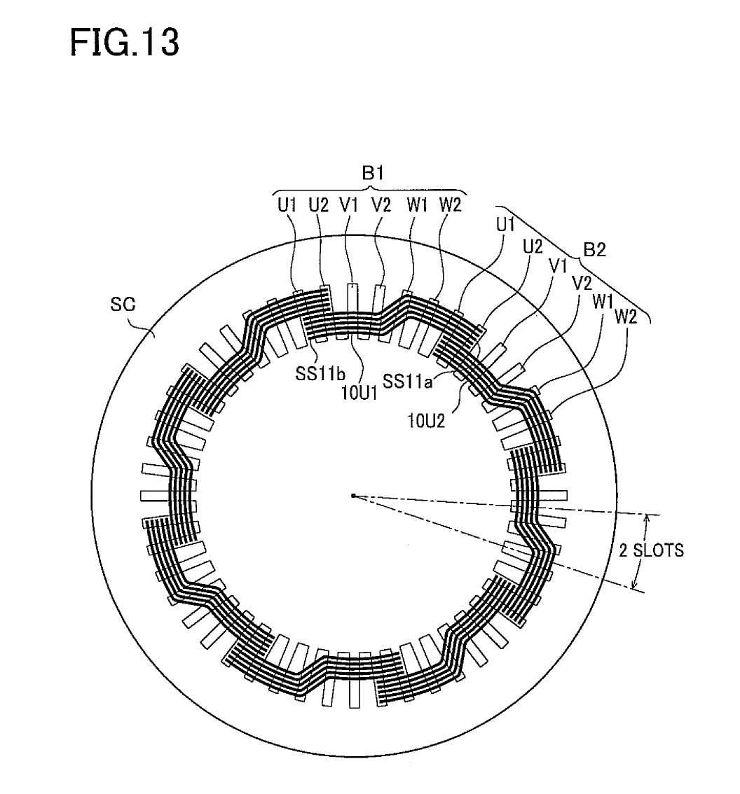

FIG. 13 is a schematic plan view showing first loops of U-phase coils in the stator core.

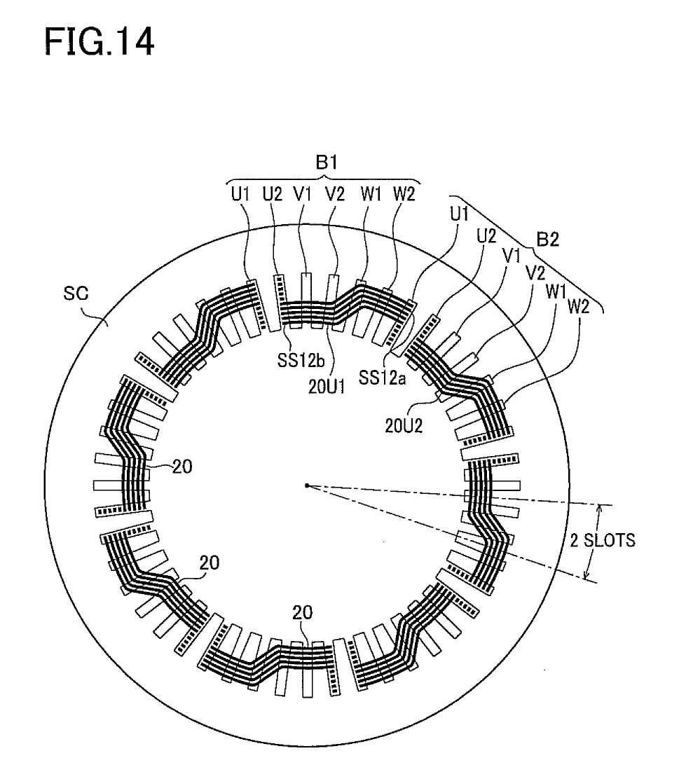

FIG. 14 is a schematic plan view showing second loops of the U-phase coils in the stator core.

Assuming that a set of a U phase, a V phase, and a W phase is referred to as one block, the stator 100 consists of eight blocks. A first block B1 includes six slots, i.e., a U-phase first slot U1B1, a U-phase second slot U2B1, a V-phase first slot V1B1, a V-phase second slot V2B1, a W-phase first slot W1B1, and a W-phase second slot W2B1.

A second block B2 includes six slots, i.e., a U-phase first slot U1B2, a U-phase second slot U2B2, a V-phase first slot V1B2, a V-phase second slot V2B2, a W-phase first slot W1B2, and a W-phase second slot W2B2.

The first loop coil 10 of the double coil 30 is arranged as shown in FIG. 13 so that a second in-slot conductor portion SS11b is inserted in the U-phase first slot U1B1 and a first in-slot conductor portion SS11a is inserted in the U-phase second slot U2B2.

On the other hand, the second loop coil 20 of the double coil 30 is arranged as shown in FIG. 14 so that a second in-slot conductor portion SS12b is inserted in the U-phase second slot U2B1 and a first in-slot conductor portion SS12a is inserted in the U-phase first slot U1B2.

The stator 100 in the first embodiment is configured as above and hence can exhibit the following operations and advantages.

Firstly, the stator 100 can develop high power and achieve downsizing.

The stator 100 in the first embodiment includes the split stator core SC including the teeth portions 43 and the slots SCS formed between the teeth portions 43, and the double coils 30 each being made of the flat rectangular conductor D and arranged in the slots SCS. The slots SCS include three-phase slot blocks including the first block B1 consisting of the U-phase first slot U1B1, the U-phase second slot U2B1, the V-phase first slot V1B1, the V-phase second slot V2B1, the W-phase first slot W1B1, and the W-phase second slot W2B1, which are arranged in sequence. Adjacent to the first block B1, the second block B2 of the three-phase slot blocks is provided. The conductor D in the first slot U1B1 of the first block B1 and the conductor D in the U-phase slot U2B2 of the second block B2 form the first loop coil 10. The conductor D in the U-phase second slot U2B1 of the first block B1 and the conductor D in the U-phase first slot U1B2 of the second block B2 form the second loop coil 20. The second loop coil 20 is placed in the inner circumference of the first loop coil 10.

Accordingly, when the stator 100 is to be formed in a distributed winding manner using concentrically wound coils formed as the double coils 30, the range to be used for the lane-change zone 33 can be ensured.

As the number of turns of each double coil 30 increases, or as the width of the flat rectangular conductor D used for the double coil 30 is thicker, the protruding lane-change zone 33 of the double coil 30 tends to be hard to form. This may become an obstacle to increasing the space factor of the stator 100 and enhancing output power. However, each double coil 30 is configured by stacking the first loop coil 10 and the second loop coil 20, so that the range to be used for the protruding lane-change zone 33 can be increased.

Accordingly, the space factor of the stator 100 can be increased, contributing to development of high output power.

To be concrete, the range for forming the lane-change zone 33 is determined to correspond to two slots as shown in FIGS. 13 and 14. It is therefore possible to increase the number of turns of the first loop coil 10 and the second loop coil 20 in the double coil 30 or increase the thickness of the flat rectangular conductor D.

In view of the minimum bending radius of the flat rectangular conductor D, damage on an insulating layer provided around the flat rectangular conductor D, and other problems, it is not preferable to bend a bending portion of the protruding lane-change zone 33 at an acute angle. Depending on which range is available for the protruding lane-change zone 33, the number of turns of the first loop coil 10 and the second loop coil 20 or the thickness of the flat rectangular conductor D are determined.

However, for development of high output power, it is essential to increase the thickness of the flat rectangular conductor D and the number of turns. Thus, it is highly advantageous to use a range corresponding to two slots (a two-slot range) for the protruding lane-change zone 33.

In the case where a single coil is used in a stator, a lane change can only use a range corresponding to one slot at most. In contrast, the stator 100 in the first embodiment using the double coils 30 allows a range corresponding to two slots to be used for forming one protruding lane-change zone 33. This configuration contributes to development of high output power of the stator 100 and also enhancement of design flexibility.

Since the first loop coil 10 and the second loop coil 20 are stacked to form the double coil 30, the space for the lane-change zone 33 is ensured as mentioned above. Thus, there is no need to elongate the coil end in the axial direction of the stator 100. This contributes to shortening of the coil end CE shown in FIG. 1.

The first terminal portion TR11a, the second terminal portion TR11b, the first terminal portion TR12a, and the second terminal portion TR12b and the bus bars BB connected to the terminal portions are connected by welding or others and then tilted radially outward as shown in FIG. 1. Consequently, the extension of the coil end CE can be minimized.

Since the coil end CE of the stator 100 is not made larger beyond necessity, the demand for downsizing can be satisfied.

Furthermore, the first loop coil 10 is provided with the lead-side protrusion PR11 and the non-lead-side protrusion PF11, the second loop coil 20 is provided with the lead-side protrusion PR12 and the non-lead-side protrusion PF12. This makes it possible to prevent the interference between adjacent coils and minimize the length of the coil end CE.

Patent Document 2 and others adopt a configuration that a first loop coil 10 and a second loop coil 20 are formed in hexagonal shape so that one apex of the hexagonal shape is located in a coil end. However, such configuration likely results in a large coil end.

This is because a flat rectangular conductor D has to be bent obliquely in the coil end portion to detour around the adjacent coils, the distance between the adjacent coils is likely to be longer unless the angle of the one apex of the hexagonal shape protruding in the coil end is made obtuse.

On the other hand, in the case where a protrusion is provided as in the first loop coil 10 and the second loop coil 20 in the first embodiment, the flat rectangular conductor D can avoid interference in three dimensions.

To be concrete, the inner circumferential zone 31 or the outer circumferential zone 32 is placed under the lane-change zone 33, so that the lane-change zones 33 are arranged in the coil end CE. This can contribute to shortening of the coil end CE.

In the first embodiment, the double coils 30 having the same shape are stacked or assembled to form the cage coil CB. Accordingly, a manufacturing cost of components can be reduced and an assembling process can be made simple.

A second embodiment of the present invention will be explained below.

### Second Embodiment

A stator 100 in the second embodiment is almost identical in structure to the stator 100 in the first embodiment, excepting a method of forming a double coil 30 in a slightly different manner from in the first embodiment. This method is explained below.

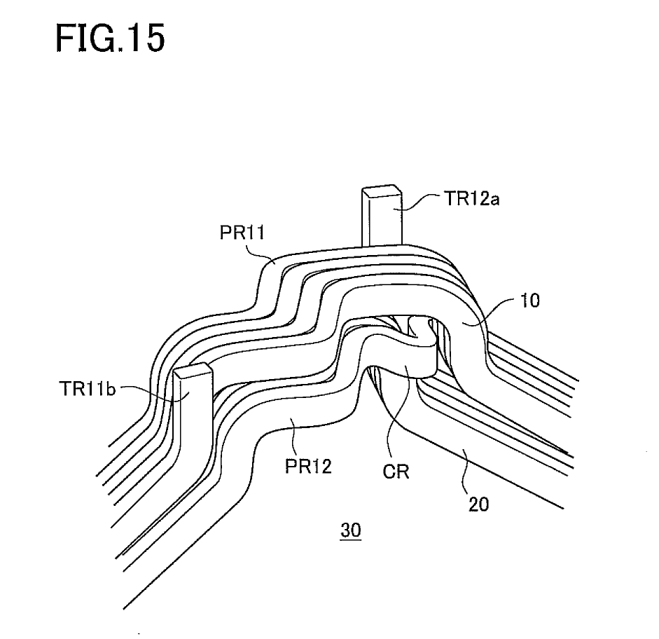

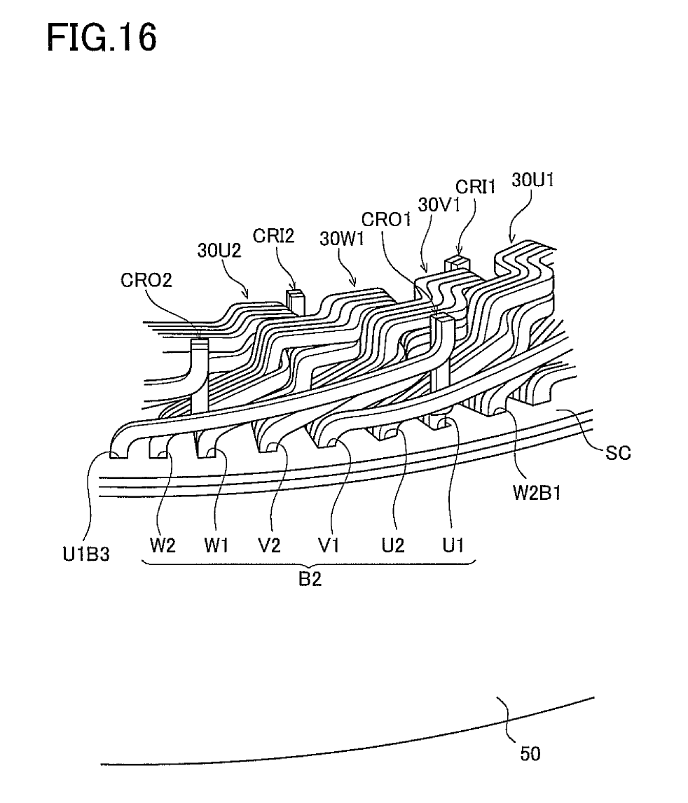

FIG. 15 is a partial perspective view of a coil end portion of a double coil in the second embodiment. FIG. 16 is a partial perspective view of a stator.

The double coil 30 used in the second embodiment includes a first loop coil 10 and a second loop coil 20 connected with a connecting portion CR shown in FIG. 15 without using a bus bar BB. That is, the first terminal portion TR11a of the first loop coil 10 is connected to the second terminal portion TR12b of the second loop coil 20 in the first embodiment shown in FIG. 2, forming the connecting portion CR as shown in FIG. 15.

The connecting portion CR passes under lead-side protrusions PR11 and goes across side surfaces of lead-side protrusions PR12 to connect the inner circumferential side to the outer circumferential side. As shown in FIG. 15, a terminal portion of the second loop coil 20 is elongated to form the connecting portion CR which is connected to the first loop coil 10 on the outer circumference side of the stator 100.

Accordingly, in each double coil 30, two parts, i.e., the second terminal portion TR11b of the first loop coil 10 and the first terminal portion TR12a of the second loop coil 20 protrude on the coil end CE side.

To form a cage coil CB from the double coils 30, forty-eight double coils are prepared in each of which the first terminal portion TR11a is connected to the second terminal portion TR12b to form the connecting portion CR. However, the second terminal portion TR11b and the first terminal portion TR12a need to be different in shape for the reason mentioned below. In practice, therefore, twenty-four double coils 30 each having a long second terminal portion TR11b and twenty-four double coils 30 each having long first terminal portion TR12a are prepared.

The first terminal portion TR12a extending from the outer circumferential side of the U-phase first slot U1B2 of the second block B2 as shown in FIG. 16 is connected to the first terminal portion TR12a extending from the outer circumferential side of the U-phase first slot U1B3 of the third block B3. This is referred to as a first outer-circumferential connecting portion CR01. That is, adjacent double coils 30 of the same phase are connected to each other. In FIG. 16, the U-phase first coil 30U1 is connected to the U-phase second coil 30U2.

Although a second terminal portion TR11b placed on the inner circumferential side is not illustrated, it is similarly connected to the second terminal portion TR11b of an adjacent coil of the same phase. In the case of FIG. 16, it is connected to a U-phase eighth coil 30U8 not shown, forming a first inner-circumferential connecting portion CR11.

Similarly, a second terminal portion TR11b of a V-phase first coil 30V1 and a second terminal portion TR11b of a V-phase second coil 30V2 placed on the inner circumferential side in the stator 100 are connected to form a second inner-circumferential side connecting portion CR12. A first terminal portion TR12a of the V-phase second coil 30V2 and a first terminal portion TR12a of a V-phase third coil 30V3 are connected to form a second outer-circumferential connecting portion CR02. In this way, the second terminal portions TR11b placed on the inner circumferential side of the stator 100 are connected to each other to form inner-circumferential connecting portions CRI and the first terminal portions TR12a placed on the outer circumferential side of the stator 100 are connected to each other to form outer-circumferential connecting portions CRO, thereby electrically connecting the double coils 30 in the stator 100. Thus, an electric circuit of the stator 100 is established.

According to the positions of the double coils 30, as mentioned above, the double coils 30 need to include a shape having the second terminal portion TR11b and having the first terminal portion TR12a both being simply extending upward and a shape having the second terminal portion TR11b and the first terminal portion TR12a both extending up to the terminal portions TR11b and TR12a of a coil of an adjacent phase. The double coils 30 are therefore prepared in two patterns.

Connection between the second terminal portions TR11b and connection between the first terminal portions TR12a of coils of adjacent phases may be conducted by use of bus bars BB.

In the stator 100 in the second embodiment having the above configuration, connecting of the first loop coil 10 and the second loop coil 20 is not conducted after the double coils 30 are combined with the split stator core SC in the stator 100. The stator 100 is therefore easy to produce.

A reduction in the number of connecting steps in the coil end CE can ensure a work space and other advantages, contributing to an increase in yield.

It is however necessary to alternately assemble the double coils 30 of two patterns, differently from the first embodiment, resulting in somewhat complicated assembling process. However, the coil end of the stator 100 in the second embodiment can be shorter than that of the stator 100 in the first embodiment. Further, the structure shown in FIGS. 15 and 16 needs no bus bar BB, which contributes to a reduction in the number of components.

A third embodiment of the present invention will be explained below.

### Third Embodiment

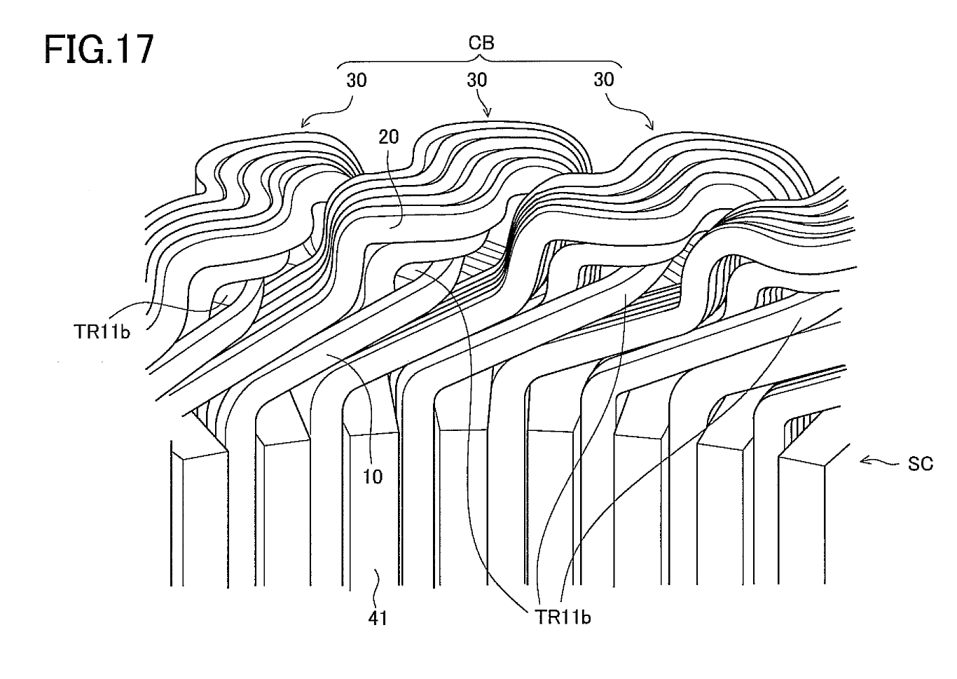

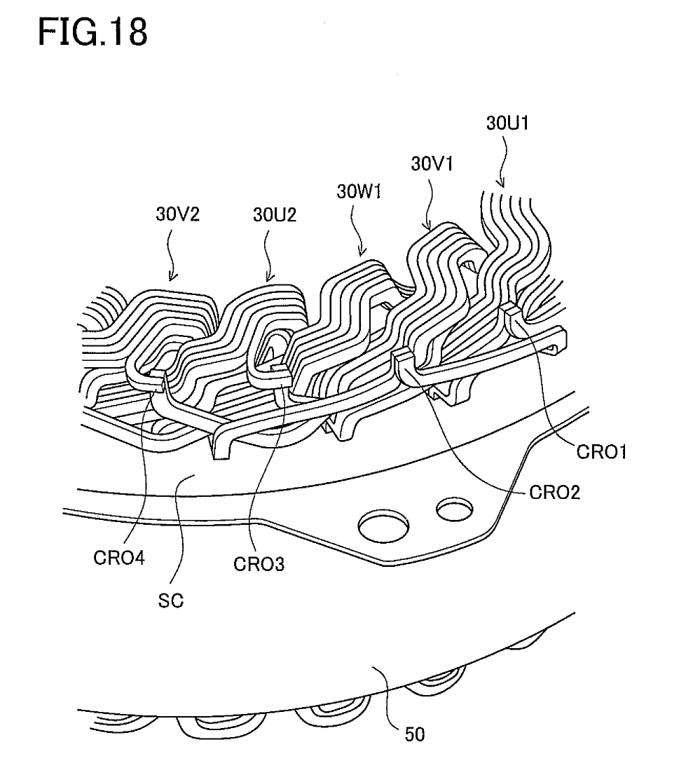

A stator 100 in the third embodiment is almost identical in structure to the stator 100 in the first embodiment, excepting the shape of the double coils 30 and a connecting method of the double coils 30, which will be explained below. FIG. 17 is a partial perspective view of a coil end portion of stacked or assembled double coils in the third embodiment, seen from the inner circumferential side. FIG. 18 is a partial perspective view of the coil end portion of the double coils seen from the outer circumferential side. The double coils 30 in the third embodiment are shown in the form of a cage coil CB in which pieces 41 of a split stator core SC are inserted. The basic shape of the double coils 30 is almost the same as the double coils 30 in the second embodiment, in which the first loop coils 10 and the second loop coils 20 are connected.

However, as shown in FIG. 18, a U-phase first coil 30U1, a V-phase first coil 30V1, and a W-phase first coil 30W1 are different in shape from a U-phase second coil 30U2 and a V-phase second coil 30V2.

Each double coil 30 is arranged so that a second terminal portion TR11b placed on the inner circumferential side of the stator 100 as shown in FIG. 17 passes under a lead-side protrusion PR12 of the second loop coil 20 to extend to the outer circumferential side.

The double coils 30 are stacked or assembled into a cage coil CB. A first outer-circumferential connecting portion CRO1 to a fourth outer-circumferential connecting portion CRO4 are formed on the outer circumferential side of the stator 100.

Since the outer-circumferential connecting portions CRO are formed on the outer circumferential side of the stator 100 in the third embodiment as above, thereby enabling electrical connection of the cage coil CB, shortening of the coil end can be achieved.

There is no need to form inner-circumferential connecting portions CRI, unlike the stator 100 in the second embodiment. Accordingly, the stator 100 in the third embodiment includes no protrusion on the inner circumferential side and thus does not interfere with a rotor not shown.

Even when the outer-circumferential connecting portions CRO project to a place corresponding to the outer circumferential portion of the split stator core SC, the connecting portions CRO interfere with nothing Accordingly, this configuration can enhance design flexibility, even though it needs somewhat complicated winding of a flat rectangular conductor D.

The present invention is explained in the above embodiments but is not limited thereto. The present invention may be embodied in other specific forms without departing from the scope of the essential characteristics thereof.

For instance, in the coil end CE in the first embodiment, the first terminal portion TR11a, the second terminal portion TR11b, the first terminal portion TR12a, and the second terminal portion TR12b may be connected as in the second and third embodiments without using the bus bars BB.

Further, the number of turns of each of the first loop coil 10 and the double coil 30 and the thickness of the flat rectangular conductor D are determined according to design requirements. For instance, the number of turns and the cross-sectional area of the flat rectangular conductor D may be increased or decreased.

Any connecting pattern of the first terminal portion TR11a, the second terminal portion TR11b, the first terminal portion TR12a, and the second terminal portion TR12b in the coil end CE may be adopted other than the connecting patterns explained in the first to third embodiments. Any other connecting patterns may be adopted as long as the double coils 30 can be efficiently utilized.

### DESCRIPTION OF THE REFERENCE SIGNS

10 First loop coil
20 Second loop coil
30 Double coil
30A Double coil
30B Double coil
31 Inner-circumferential zone
32 Outer-circumferential zone
33 Lane-change portion
41 Piece
43 Teeth portion
50 Outer ring
55 Terminal stand
100 100 Stator
B1 First block
B2 Second block
BB Bus bar
C1 Initial coil
C2 Protrusion including coil
C3 Curve including coil
C4 Lane-change including coil
CB Cage-shaped coil
CE Coil end
CR Connecting portion
D Flat rectangular conductor
LCF11 Non-lead-side lane-change portion
LCF12 Non-lead-side lane-change portion
LCR11 Lead-side lane-change portion
LCR12 Lead-side lane-change portion
PF11 Non-lead-side protrusion
PF12 Non-lead-side protrusion
PR11 Lead-side protrusion
PR12 Lead-side protrusion

1. A stator comprising: a stator core including teeth portions and slots formed between the teeth portions; and coils each being made of a flat rectangular conductor and placed in the slots,
wherein the slots include three-phase slot blocks including a first group consisting of a U-phase first slot, a U-phase second slot, a V-phase first slot, a V-phase second slot, a W-phase first slot, and a W-phase second slot, which are arranged in sequence, and a second group of the three-phase slot blocks being arranged adjacent to the first group,
the conductor placed in a U-phase first slot of the first group and the conductor placed in a U-phase second slot of the second group forms a first loop,
the conductor placed in a U-phase second slot of the first group and the conductor placed in a U-phase first slot of the second group forms a second loop,
the second loop is placed on an inner circumference of the first loop, and
the conductor extending from the U-phase first slot is deformed for a lane change in a range corresponding to two slots.

2. (canceled)

3. The stator according to claim 1, wherein
a coil end portion of the first loop is formed with a first protrusion, and
a coil end portion of the second loop is formed with a second protrusion placed on an inner circumference of the first protrusion.

4. The stator according to claims 1, wherein one end of the first loop is connected to one end of the second loop.

5. A method of manufacturing a stator comprising: a stator core including teeth portions and slots formed between the teeth portions; and coils each being made of a flat rectangular conductor and placed in the slots, the method including:
a first step of winding the conductor in a plurality of turns in an overlapping relation to form an octagonal coil;
a second step of forming a pair of protrusions in coil end portions of the octagonal coil;
a third step of forming the coil formed with the protrusions into a circular arc shape; and
a fourth step of forming lane-change portions in the pair of protrusions.

6. The stator manufacturing method according to claim 5, wherein
the second step includes pressing an outer surface of the octagonal coil by a press mechanism from surrounding four directions of the fixed octagonal coil to form the pair of protrusions.

7. The stator manufacturing method according to claim 5, wherein
the third step includes fixing the coil formed with the protrusions and then pressing a die having a curved surface against the coil formed with the protrusions in an axial direction to form the coil including the protrusions into the circular arc shape.

8. The stator manufacturing method according to claim 5, wherein
the fourth step includes holding the pair of protrusions of the coil formed in the circular arc shape by a right holding die and a left holding die and then displacing the left holding die with respect to the right holding die to form the lane-change portion in the pair of protrusions.

9. A stator manufacturing apparatus for manufacturing a stator comprising: a stator core including teeth portions and slots formed between the teeth portions; and coils each being made of a flat rectangular conductor and placed in the slots,
wherein a coil fixing part for fixing an octagonal coil formed of the conductor wound in a plurality of turns in an overlapping relation; and
a press mechanism for pressing an outer surface of the octagonal coil from surrounding four directions of the fixed octagonal coil,
a pair of protrusions is formed in the octagonal coil.

10. The stator manufacturing apparatus according to claim 9, further including:
a fixing mechanism for fixing both ends of the coil formed with the protrusions; and
a die having a curved surface which is pressed against the coil formed with the protrusions in an axial direction of the coil,
the apparatus being configured to form the coil formed with the protrusions into a circular arc shape.

11. The stator manufacturing apparatus according to claim 10, further including:
a right holding die and a left holding die for holding the pair of protrusions formed in the circular arc shape, and
a drive mechanism for displacing the left holding die with respect to the right holding die,
a lane-change portion is formed in each of the pair of protrusions of the coil formed into the circular arc shape.

12. The stator according to claim 3, wherein one end of the first loop is connected to one end of the second loop.

13. The stator manufacturing method according to claim 6, wherein
the third step includes fixing the coil formed with the protrusions and then pressing a die having a curved surface against the coil formed with the protrusions in an axial direction to form the coil including the protrusions into the circular arc shape.

14. The stator manufacturing method according to claim 6, wherein
the fourth step includes holding the pair of protrusions of the coil formed in the circular arc shape by a right holding die and a left holding die and then displacing the left holding die with respect to the right holding die to form the lane-change portion in the pair of protrusions.

15. The stator manufacturing method according to claim 7, wherein
the fourth step includes holding the pair of protrusions of the coil formed in the circular arc shape by a right holding die and a left holding die and then displacing the left holding die with respect to the right holding die to form the lane-change portion in the pair of protrusions.

16. The stator manufacturing method according to claim 13, wherein
the fourth step includes holding the pair of protrusions of the coil formed in the circular arc shape by a right holding die and a left holding die and then displacing the left holding die with respect to the right holding die to form the lane-change portion in the pair of protrusions.
